(19) United States
(12) Patent Application Publication
(10) Pub. No.: US 2026/0360787 A1
(43) Pub. Date: Nov. 12, 2026

(54) SUBASSEMBLY FOR A FUEL CELL STACK, FUEL CELL COMPRISING SUCH A SUBASSEMBLY AND METHOD FOR MANUFACTURING SUCH A SUBASSEMBLY

(71) Applicant: SYMBIO FRANCE, Saint-Fons (FR)

(72) Inventors: Vincent Fabrice ROSSIGNOL, VENISSIEUX (FR); Clément Guillaume SANTINI, SAINTE FOY LES LYON (FR)

(21) Appl. No.: 19/138,002

(22) PCT Filed: Dec. 13, 2023
(86) PCT No.: PCT/EP2023/085657

§ 371 Date: Jun. 11, 2025

(30) Foreign Application Priority Data
Dec. 14, 2022 (FR) FR2213386

(51) Int. Cl. H01M 8/242; H01M 8/0258; H01M 8/0273; H01M 8/0284; H01M 8/0297; H01M 8/1004; H01M 8/2465

(52) U.S. Cl. CPC H01M 8/242; H01M 8/0258; H01M 8/0273; H01M 8/0284; H01M 8/0297; H01M 8/1004; H01M 8/2465

(57) ABSTRACT

This sub-assembly for fuel cell stack comprises at least one first bipolar half-plate (42) and a membrane-electrode assembly comprising a membrane and a bipartite frame (30) formed by a first half-frame (32) and a second half-frame (34). At least the second half-frame (34) is coated, on a first surface (S34) facing a first surface (S32) of the first half-frame, with a layer of securing adhesive. First openings (320) arranged through the first half-frame (32) are each disposed facing a solid portion (42A) of the first bipolar half-plate and facing a solid portion (34A) of the second half-frame, in a direction perpendicular to a main plane of the membrane (π22). The first bipolar half-plate (42) is secured to the frame (30) by a quantity (Q2) of adhesive that extends through the first openings (320) and comes from the adhesive coated on the first surface (S34) of the second half-frame (34).

The present invention relates to a subassembly intended to be integrated into a stack of electrochemical cells within a fuel cell. The invention also relates to a fuel cell comprising a stack of electrochemical cells, at least one of which comprises, or is constituted by, such a subassembly. Finally, the invention relates to a method for manufacturing a subassembly as mentioned above.

In the field of fuel cells, it is known to insert a stack of electrochemical cells between two terminal plates, located on either side of this stack in a stacking direction, and possibly to place this stack in a casing. The electrochemical cells are formed by membrane-electrode assemblies and bipolar plates. A membrane-electrode assembly is sometimes referred to as MEA, from the English “Membrane-Electrode Assembly,” and generally comprises a base membrane, which can be coated on one or both sides with a catalytic layer comprising a catalyst, as well as a frame that supports this membrane. The frame may include openings that, in the stack, define fluid flow galleries within the stack of electrochemical cells for the distribution and recovery of these fluids in the corresponding fluid compartments of each cell. This frame is most often associated with at least one seal, sometimes referred to as a “gasket,” with which it also ensures a sealing function for the flow of fluids within the stack.

The membrane, when coated with layers comprising a catalyst, is sometimes referred to as CCM, from the English “Catalyst Coated Membrane,” and in this case comprises three layers, namely, a membrane proper, a catalytic layer on the anode side, and a catalytic layer on the cathode side.

In the stack, a membrane-electrode assembly is interposed between two bipolar plates, thereby delimiting an anode compartment and a cathode compartment. On each side, the catalyst-coated membrane is covered by a gas diffusion layer, which is thereby received in the corresponding anode or cathode compartment and promotes the contact of the chemical species present in the corresponding anode or cathode compartment with the membrane. Each gas diffusion layer also has a role in conducting electrons. These diffusion layers are sometimes referred to as GDL, from the English “Gas Diffusion Layer.”

It is known to manufacture a membrane-electrode assembly by attaching the catalyst-coated membrane to the frame, which notably allows this membrane to be stiffened and facilitates the handling thereof. This is done by leak-tight bonding of the membrane to the frame.

It is known to produce, during the manufacture of a fuel cell, bipolar plates formed of two half-plates or metal foils that belong to two adjacent electrochemical cells. This requires separately handling the membrane-electrode assemblies, on the one hand, and the bipolar plates, on the other hand, during the placement thereof within the stack of a fuel cell. This solution requires joining the two half-plates or foils of a bipolar plate together. This joining can be done by laser welding or brazing, notably point-by-point, by plastic deformation of the foils, notably using an electric tool creating an impact, or by bonding. However, it is also known to have bipolar plates formed of two half-plates or metal foils that belong to two adjacent electrochemical cells, the two half-plates being only held in contact with each other by the compression of the stack, generally with the interposition of one or a plurality of seals, which can be free seals or seals integrated into one or the other of the half-plates.

Once the membrane-electrode assemblies, on the one hand, and the bipolar plates, on the other hand, are constituted, they must be alternately arranged along the stacking direction, which proves in practice to be long and delicate to implement.

It is known from WO-A-2014/111745 and U.S. Pat. No. B8,399,150 to bond an electrochemical cell frame to a bipolar plate by means of an adhesive layer interposed between these parts. This approach requires joining the foils of the bipolar plates according to one of the techniques mentioned hereinabove and providing a quantity of adhesive dedicated to creating the bond between the frame and the bipolar plate. This approach imposes the way to subsequently constitute the stack of electrochemical cells of the fuel cell and increases the cost thereof, both in terms of investment for the means of applying the adhesive and in terms of the cost of this added adhesive.

It is further known from JP2008084707A to distribute glue points between the two half-frames of a frame surrounding an electrochemical cell membrane and to drill through holes in these half-frames that are aligned in a direction perpendicular to the plane of the membrane. A half-bipolar plate is attached to each half-frame by means of other glue points. This assembly technique with glue points requires a relatively large amount of glue. Each half-bipolar plate is directly joined only to the adjacent half-frame. In addition, the glue placed between the two half-frames may overflow on one side of the subassembly thereby produced.

It is these disadvantages that the invention particularly aims to remedy by proposing a new subassembly for a fuel cell stack, the manufacture of which is simplified and the cost of which can be reduced compared to previous equipment.

To this end, the invention relates to a subassembly for a fuel cell stack comprising a membrane-electrode assembly comprising a membrane and a bipartite frame formed by a first half-frame disposed on a first side of the membrane and a second half-frame disposed on a second side of the membrane. The membrane-electrode assembly further comprises at least one first half-bipolar plate. At least the second half-frame is coated, on a first surface facing a first surface of the first half-frame, with a layer of glue for joining the half-frames.

According to the invention, first openings arranged through the first half-frame are each disposed facing a solid portion of the first half-bipolar plate and facing a solid portion of the second half-frame, in a direction perpendicular to a main plane of the membrane. In addition, the first half-bipolar plate is joined to the frame by a quantity of glue that extends through the first openings and comes from the glue coated on the first surface of the second half-frame.

By means of the invention, the structure of the subassembly allows for the use of the glue layer provided primarily to join the two frames of the membrane-electrode assembly to ensure an additional function of immobilizing the first half-bipolar plate. This allows this subassembly to be handled as a unit during the manufacture of a fuel cell incorporating said glue layer, which facilitates the work of an operator or a robot and allows production rates to be increased, thereby reducing the cost of the fuel cell. In addition, the mode of joining between the first half-bipolar plate and the frame is precise since the quantity of glue that extends through the first openings is well positioned in space, due to these first openings. In particular, this quantity of glue does not risk flowing outside the subassembly of the invention. In addition, in the case where the subassembly comprises a second half-bipolar plate, it constitutes a unitary electrochemical cell that can be tested, or even pre-activated, before the incorporation thereof into a stack of cells, which makes a manufacturing process of such a cell more reliable.

According to advantageous but non-mandatory aspects of the invention, such a subassembly can incorporate one or a plurality of the following features, taken in any technically admissible combination:
The subassembly comprises a second half-bipolar plate disposed, relative to the membrane, opposite the first bipolar plate. The first half-frame is coated, on the first surface thereof, with a layer of glue for joining the half-frames. Second openings arranged through the second half-frame are each disposed facing a solid portion of the second half-bipolar plate and facing a solid portion of the first half-frame, in the direction perpendicular to a main plane of the membrane. In addition, the second bipolar plate is joined to the frame by a quantity of glue that extends through the second openings and comes from the glue coated on the first surface of the first half-frame.
The first and second openings are offset from each other in at least one direction parallel to the main plane of the membrane, so that there is no overlap between these openings in the direction perpendicular to the main plane of the membrane.
The first half-bipolar plate is provided with cutouts aligned with the second openings and/or the second half-bipolar plate is provided with cutouts aligned with the first openings, in the direction perpendicular to the main plane of the membrane.
A cutout opens onto at least one longitudinal edge of the bipolar plate wherein said cutout is formed.
Each opening arranged through a half-frame has a cross-section the area of which is greater than or equal to 5 mm², preferably 10 mm², with a preferably circular, rectangular, or oblong shape.
The glue is heat activated and based on thermoplastic polymer, notably EVA copolymer.
At least one of the first openings arranged through the first half-frame is arranged in an external peripheral zone of the subassembly that is located outside relative to a peripheral sealing gasket of the subassembly.
The membrane-electrode assembly includes four corners, while the subassembly includes at least four first openings arranged through the first half-frame and arranged in an external peripheral zone of the subassembly that is located outside relative to a peripheral sealing gasket of the subassembly, each in a corner of the membrane-electrode assembly.
At least one of the first openings arranged through the first half-frame and the solid portion facing said half-frame belonging to the first half-bipolar plate are arranged in a gallery framing zone, arranged around an opening of the first half-bipolar plate, and fluidically isolated from at least one anodic or cathodic fluid compartment delimited in the subassembly, between the membrane-electrode assembly and the first half-bipolar plate.

According to another aspect, the invention relates to a fuel cell comprising a stack of electrochemical cells, each with a membrane-electrode assembly and two half-bipolar plates, at least one of these cells comprising, or being constituted by, a subassembly as mentioned above.

This fuel cell presents the same advantages as those mentioned hereinabove.

According to a third aspect, the invention relates to a method for manufacturing a subassembly, notably a subassembly as mentioned above, comprising a membrane-electrode assembly comprising a membrane and a bipartite frame formed by a first half-frame disposed on a first side of the membrane and a second half-frame disposed on a second side of the membrane. The membrane-electrode assembly also comprises at least a first half-bipolar plate. This method comprises at least a preliminary step of coating at least a first surface of the second half-frame with glue and a step of joining the frame and the membrane by applying the first surface of the second half-frame, coated with glue, against the first surface of the first half-frame.

According to the invention, this method comprises at least a step of applying the first half-bipolar plate against a second surface of the first half-frame opposite the first surface of this first half-frame and a step of joining the first half-bipolar plate and the frame by migration of the glue coated on the first surface of the second half-frame, towards a surface of the first half-bipolar plate, through first openings arranged in the first half-frame, between the first and second surfaces thereof.

This method allows for the formation of electrochemical cells or parts of electrochemical cells that can be easily integrated into a stack of fuel cell cells, using a technique that can be well mastered, with high production rates.

Advantageously, the subassembly comprises a second half-bipolar plate and the method comprises at least a preliminary step of coating at least a first surface of the first half-frame with glue, a step of applying the second half-bipolar plate against a second surface of the second half-frame opposite the first surface of this second half-frame and a step of joining the second half-bipolar plate and the frame by migration of the glue coated on the first surface of the first half-frame, towards a surface of the second half-bipolar plate, through first openings arranged in the second half-frame, between the first and second surfaces thereof.

Provision can also be made that, during the joining step, the glue coated on the first surface of the second half-frame, and possibly on the first surface of the first half-frame, is heated at least in the vicinity of the first openings, and possibly at the level of the second openings.

The invention will be better understood and other advantages thereof will appear more clearly in light of the following description of four embodiments of a subassembly, a fuel cell, and a method according to the principle thereof, given solely by way of example and made with reference to the appended drawings wherein:

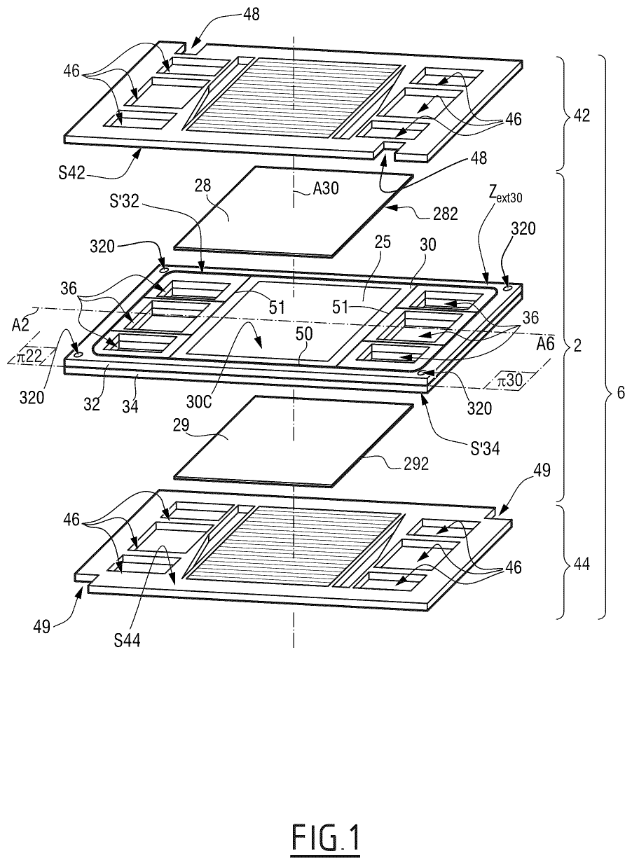

FIG. 1 is a partially exploded perspective view of a subassembly according to a first embodiment of the invention, this subassembly constituting an electrochemical cell belonging to a stack of a fuel cell;

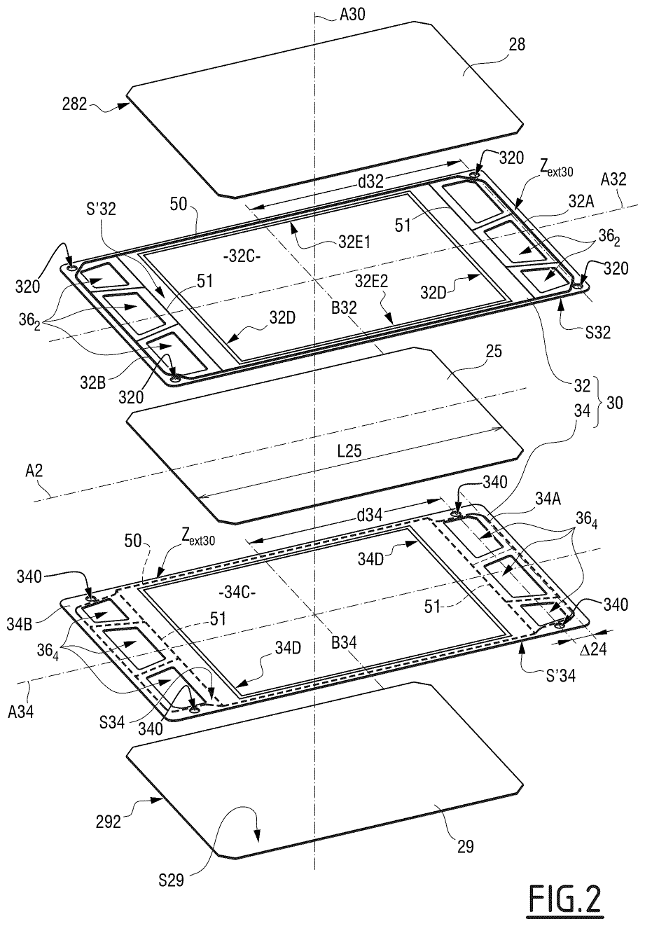

FIG. 2 is an exploded perspective view of a membrane-electrode assembly belonging to the subassembly shown in FIG. 1;

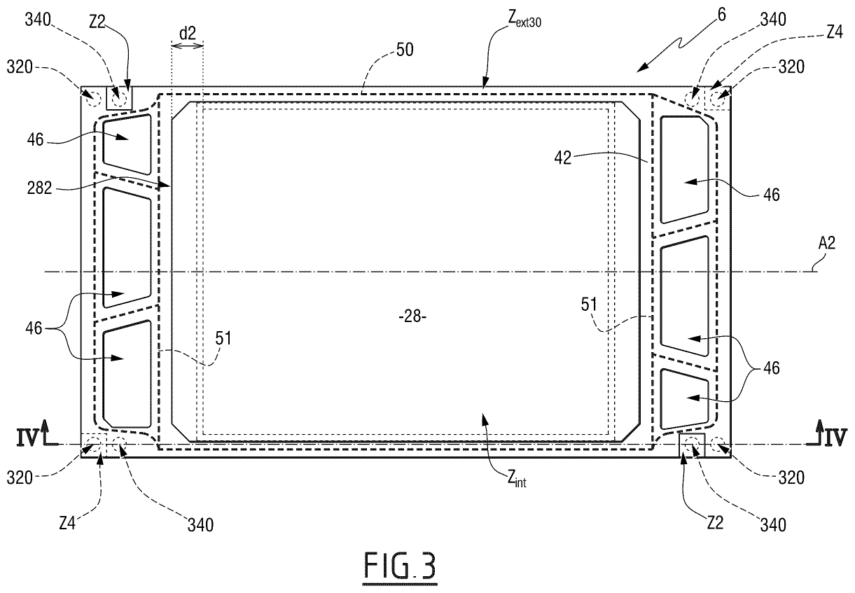

FIG. 3 is a front view of the subassembly shown in FIG. 1;

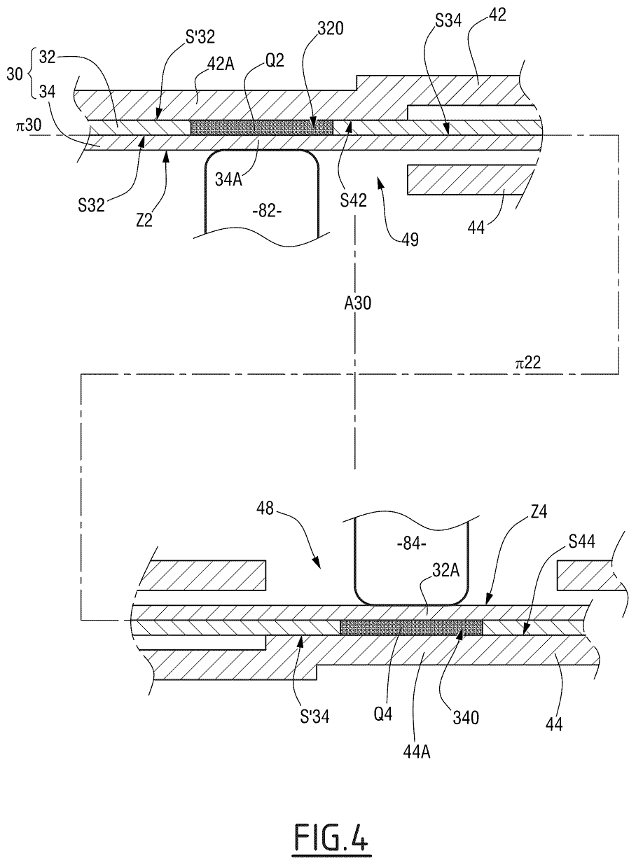

FIG. 4 is a longitudinal section of the subassembly shown in FIGS. 1 and 3, along line IV-IV in FIG. 3, during a step of manufacturing a fuel cell comprising this subassembly;

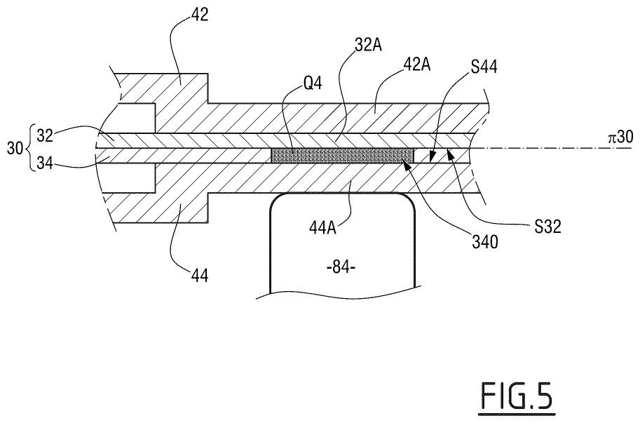

FIG. 5 is a partial view, similar to FIG. 4, for a subassembly according to a second embodiment of the invention.

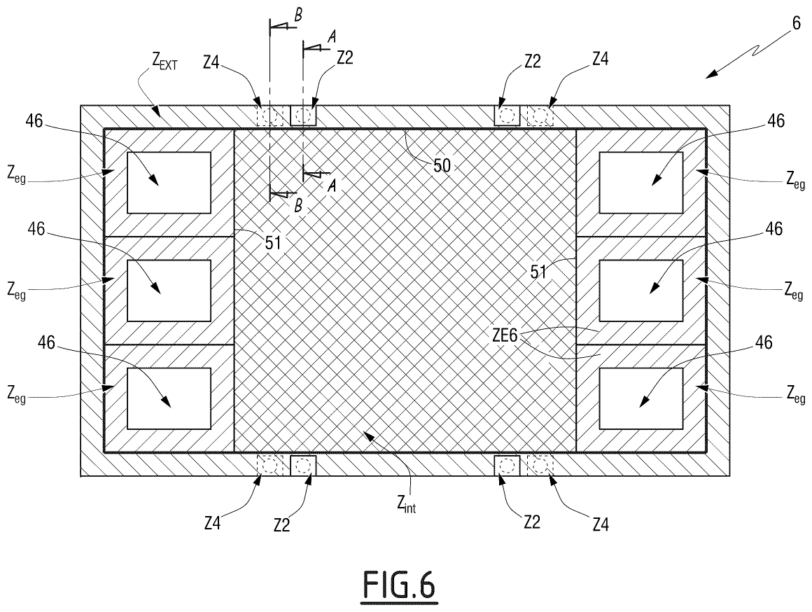

FIG. 6 is a simplified front view, similar to FIG. 3, for a subassembly according to a third embodiment of the invention;

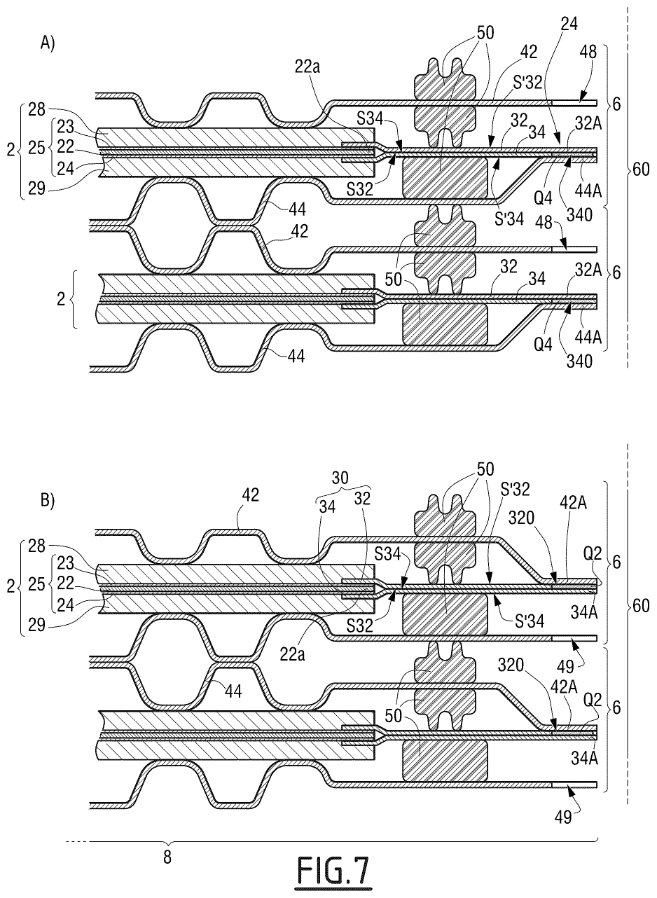

FIG. 7 shows, in two inserts A) and B) and on a larger scale, partial sections at the cutting lines A-A and B-B in FIG. 6 in the case where the subassembly is integrated into a stack of electrochemical cells; and

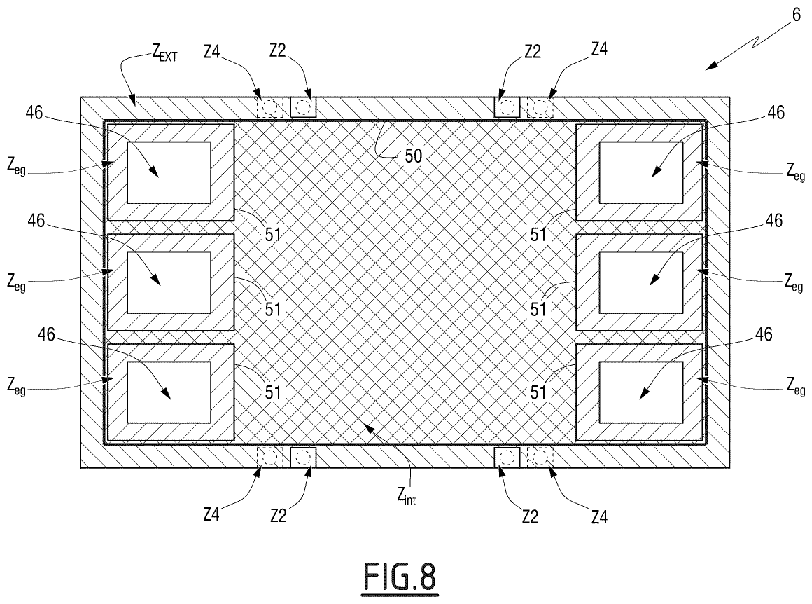

FIG. 8 is a simplified front view, similar to FIG. 6, for a subassembly according to a fourth embodiment of the invention.

To clearly show the features of the invention, the proportions are not necessarily respected between the objects shown in the figures.

A membrane-electrode assembly 2 is shown in a partially exploded view in FIG. 1. This assembly 2 is associated with a first half-bipolar plate 42 and a second half-bipolar plate 44 to form a subassembly 6 intended to constitute an electrochemical cell, designed to be part of a stack, this stack constituting part of a fuel cell. Such a stack is shown with reference 60, in FIG. 7, within a partially visible fuel cell 8, for the third embodiment of the invention.

The half-bipolar plates 42 and 44 can also be referred to as polar plates.

A2 denotes a longitudinal axis of the membrane-electrode assembly 2, which is coincident with a longitudinal axis A6 of the subassembly 6.

The membrane-electrode assembly 2 can be referred to as MEA and comprises a base membrane 22 which, in the example described below, is coated with a catalyst. More precisely, the base membrane 22 is a proton exchange polymer membrane. The structure of the membrane-electrode assembly 2 is the same as that visible in FIG. 7 for the third embodiment. The membrane-electrode assembly is described with reference to this FIG. 7. The base membrane 22 is thereby, in the example, coated, on a first side oriented upwards in FIGS. 1, 2, and 7, with a first catalytic layer 23 forming a cathode and, on a second side opposite the first side and oriented downwards in FIGS. 1, 2, and 7, with a second catalytic layer 24 forming an anode. The membrane 22 and the catalytic layers 23 and 24 together form a catalyst-coated membrane 25, otherwise referred to as CCM. In the rest of this description, this catalyst-coated membrane 25 is referred to as membrane CCM. Here, the base membrane 22 is made of a polymer material, notably of the NAFION type (registered trademark), and has a thickness of about 0.005 to 0.050 mm, preferably 0.008 to 0.015 mm. The catalytic layers 23 and 24 are made from a platinum base and each have a thickness of about 0.001 to 0.010 mm, preferably 0.002 to 0.005 mm. The thickness of the CCM membrane 25 is preferably between 0.008 and 0.050 mm, preferably about 0.017 mm.

π22 denotes a median plane of the base membrane 22, which is also a median plane of the CCM membrane 25. The longitudinal axis A2 is comprised in the median plane π22.

The CCM membrane 25 is mounted on a frame 30 consisting of two half-frames 32 and 34 that are intended to come into planar contact with each other and are, e.g., made of polymer film, e.g., poly(ethylene terephthalate) or PET or poly(ethylene naphthalate) or PEN.

π30 denotes a contact plane of the two half-frames 32 and 34 against each other. The plane π30 is also a median plane of the frame 30 and it comprises the longitudinal axis A2. The two half-frames 32 and 34 are configured to trap between them a peripheral edge 22a of the membrane 22 when they are in contact with each other along the plane π30. In this configuration, the half-frames 32 and 34 form a zone, also called “overlap,” between the membrane 22 and the two half-frames 32, 34. Along each longitudinal edge or each transverse edge of the frame, the overlap has a width, e.g., comprised in the range from 1 to 5 mm, preferably in the range from 2 to 4 mm.

The half-frame 32 is disposed on a first side of the CCM membrane 25, in the example above the membrane in FIGS. 1, 2, and 7, while the half-frame 34 is disposed on a second side of the CCM membrane 25, in the example below the membrane in FIGS. 1, 2, and 7. This has the effect of immobilizing the membrane 22, i.e. in practice, the CCM membrane 25, by pinching said membrane between the half-frames 32 and 34, within the frame 30.

Advantageously, the thickness of each of the half-frames 32 and 34 is between 0.020 and 0.030 mm, preferably about 0.025 mm.

The frame 30 allows the CCM membrane 25 to be stiffened and held in position within the stack.

In practice, the half-frames 32 and 34 are joined against each other at the contact plane π30, preferably by means of glue.

Preferably, as can be seen in FIG. 4, e.g., the glue is not deformed and remains parallel to the plane π30.

S32 denotes the surface of the half-frame 32 facing the half-frame 34. S34 denotes the surface of the half-frame 34 facing the half-frame 32. In the mounted configuration of the frame 30 around the membrane 22, the surfaces S32 and S34 are in surface contact with each other, aligned on the plane π30, and joined to each other by means of the glue. In this configuration, the median plane π22 of the membrane 22 is also aligned on the plane π30.

The glue used to assemble the half-frames 32 and 34 is preferably a thermo-activable glue based on thermoplastic polymer, e.g., a glue based on EVA copolymer, such as the glue marketed under the reference AP12 by the company Micel.

Advantageously, the thickness of the glue layer coated, i.e. deposited, on the surface S32 or S34 of each of the half-frames is between 0.01 to 0.02 mm, preferably about 0.013 mm, before applying the surfaces S32 and S34 against each other.

Advantageously, the frame 30 defines openings 36 intended to form circulation and distribution/collection galleries of fluid within the stack when several subassemblies 6 are juxtaposed within the stack, in a direction perpendicular to their median planes π30.

The openings 36 are constituted by aligning, in directions parallel to the axis A30, individual openings 362 and 364 formed respectively in the half-frames 32 and 34.

Alternatively, notably in the case of a so-called “external manifold” fuel cell, the frame 30 is devoid of openings of the type of openings 36.

A30 denotes an axis perpendicular to the plane π30 and passing through the geometric center of the frame 30. The axis A30 is perpendicular to the base membrane 22, as well as to the CCM membrane 25, thereby to the median plane π22 thereof.

Within the stack, the axes A30 of the different frames 30 are coincident, and the frames 30 are oriented around this axis so that the openings 36 together constitute circulation and distribution/collection galleries of fluid, notably hydrogen, air, or heat transfer fluid, within the stack.

Each half-bipolar plate 42 or 44 is equipped with openings 46 of the same geometry as the openings 36 and which also participate in the definition of these galleries.

32A and 32B respectively denote the longitudinal ends of the half-frame 32. 34A and 34B respectively denote the longitudinal ends of the half-frame 34.

A32 and A34 respectively denote a longitudinal axis of the half-frame 32 and a longitudinal axis of the half-frame 34. In the mounted configuration of the membrane-electrode assembly 2, the axes A2, A32, and A34 are perpendicular to the axis A30, parallel to each other, and preferably almost coincident, with the thickness of the half-frames. B32 and B34 respectively denote a transverse axis of the half-frame 32 and a transverse axis of the half-frame 34, respectively perpendicular to the axes A32 and A34. In the mounted configuration of the membrane-electrode assembly 2, the axes B32 and B34 are perpendicular to the axis A30, parallel to each other, and preferably almost coincident, to the thickness of the half-frames.

The half-frames 32 and 34 each define a central opening 32C, and 34C respectively, which passes through them from side to side and in front of which the CCM membrane 25 is disposed in the mounted configuration of this membrane on the frame 30. The central openings 32C and 34C of the half-frames 32 and 34 are thereby delimited by internal edges of these half-frames. The combination of the central openings 32C and 34C defines a central opening 30C of the frame 30, which is closed by the CCM membrane in the mounted configuration of the membrane-electrode assembly 2. The half-frames 32 and 34, and thereby the frame 30 they constitute, have a closed contour around the corresponding central opening.

32D denotes the transverse edges of the central opening 32C of the half-frame 32, each transverse edge being parallel to the axis B32. 34D denotes the transverse edges of the central opening 34C of the half-frame 34, each transverse edge being parallel to the axis B32.

Advantageously, the membrane-electrode assembly 2 also comprises a first gas diffusion layer 28 and a second gas diffusion layer 29, which can be referred to as GDL and which have the function of promoting exchanges between the CCM membrane 25 and the fluids circulating between the two half-bipolar plates 42 and 44 of a subassembly 6 to which this membrane-electrode assembly belongs.

Advantageously, the thickness of the diffusion layers 28 and 29 is between 0.050 and 0.320 mm, preferably about 0.250 mm.

In the mounted configuration of the membrane-electrode assembly 2, the diffusion layers 28 and 29 cover the CCM membrane 25 and part of the frame 30, near the central opening 30C, each on one side of the CCM membrane 25.

To allow for the immobilization of the half-bipolar plates 42 and 44 on the frame 30 equipped with the CCM membrane 25, each of the half-frames 32 and 34 is equipped with first openings 320, and second openings 340 respectively, which are disposed on either side of the central opening 32C or 34C thereof, along the longitudinal axis A32 or A34 thereof, and on either side of the individual openings 362 or 364 thereof along the transverse axis B32 or B34 thereof. The first openings 320 are intended to be covered by the half-bipolar plate 42, while the second openings 340 are intended to be covered by the half-bipolar plate 44, in the mounted configuration of the subassembly 6. Thereby, in the mounted configuration of the subassembly 6, the openings 320 and 340 are disposed facing the half-bipolar plates 42 and 44, in a direction parallel to the axis A30, i.e. in a direction perpendicular to the planes π22 and π30.

In the example, the openings 320 of the half-frame 32 are four in number, as are the openings 340 of the half-frame 34.

In an unrepresented variant, a different number of openings 320 and 340 may be provided, or even openings in different numbers on the two half-frames.

The half-frame 32 comprises two rows of two openings 320 that respectively extend near the ends 32A and 32B of the half-frame 32, on either side of the individual openings 36₂, and that connect the surface S32 of the half-frame 32 to a surface S′32 of the half-frame 32 that is opposite the surface S32 and on which the first half-bipolar plate 42 and the diffusion layer 28 rest. The openings 320 thereby pass through the thickness of the half-frame 32.

Similarly, the half-frame 34 comprises two rows of two openings 340 that respectively extend near the ends 34A and 34B of the half-frame 34, on either side of the individual openings 364, and that connect the surface S34 of the half-frame 34 to a surface S′34 of the half-frame 34 that is opposite the surface S34 and on which the second half-bipolar plate 42 and the diffusion layer 28 rest. The openings 340 thereby pass through the thickness of the half-frame 34.

Advantageously, the openings 320 are distributed on the first half-frame 32 symmetrically with respect to the axes A32 and B32. Similarly, the openings 340 are distributed on the first half-frame 34 symmetrically with respect to the axes A34 and B34.

Advantageously, the openings 320 are further from the transverse edges 32D than the openings 340 are from the transverse edges 34D. Thereby, the openings 320 and 340 are offset from each other, in a direction parallel to the longitudinal axes A32 and A34, so that there is no overlap between these openings in the direction of the axis A30.

d32 denotes a distance measured parallel to the axis A32 between the axis B32 and a line passing through the geometric centers of the openings 320. d34 denotes a distance measured parallel to the axis A34 between the axis B34 and a line passing through the geometric centers of the openings 340. The distances d32 and d34 are different. In the example, the distance d32 is greater, by a non-zero difference Δ24, compared to the distance d34, and this difference Δ24 induces an offset between the openings 320 and 340, parallel to the longitudinal axes A32 and A34, such that there is no overlap between them.

According to an unrepresented variant of the invention, in addition to or instead of the offset in a direction parallel to the longitudinal axes A32 and A34, the openings 320 and 340 are offset from each other, in a direction parallel to the transverse axes B32 and B34, which also avoids overlap between these openings in a direction parallel to the axis A30.

S42 denotes the surface of the first half-bipolar plate 42 facing the frame 30 in the assembled configuration of the subassembly 6. S44 denotes the surface of the second bipolar plate 44 facing the frame 30 in the assembled configuration of the subassembly 6.

In the assembled configuration of the subassembly 6, each opening 320 extends, through the half-frame 32, between the surfaces S34 and S42, while each opening 340 extends, through the half-frame 34, between the surfaces S32 and S44.

Near two of the opposite corners thereof, the first half-bipolar plate 42 is provided with two cutouts 48 that open onto two opposite longitudinal edges of this half-plate and that give access, from above in FIG. 1, to two zones Z2 of the first half-frame 32 that are opposite with respect to the axes A32 and B32 and that cover from above, the openings 340 of the second half-frame 34 when the subassembly 6 is mounted. Similarly, the second half-bipolar plate 44 is provided, at two of the opposite corners thereof, with two cutouts 49 that open onto two longitudinal edges and two opposite transverse edges of this half-plate and that give access, from below in FIG. 1, to two zones Z4 of the second half-frame 34 that are opposite with respect to the axes A34 and B34 and that cover from below the openings 320 of the first half-frame 32 when the subassembly 6 is mounted.

A system of peripheral sealing gaskets 50 is disposed between the frame 30 and the half-bipolar plates 42 and 44, on each side of the frame. In practice, two peripheral sealing gaskets 50 are provided, one on the surface S′32, the other on the surface S′34. These sealing gaskets 50 surround both the central opening 30C and the openings 36 of the frame, so that they ensure sealing, with respect to the outside of the subassembly 6, for each of the operational fluids of the cell, namely hydrogen, oxygen, air, and any cooling fluid. These peripheral sealing gaskets 50 thereby fluidically isolate the cathodic compartment from the outside and the anodic compartment from the outside.

Each of the openings 36, 46 is also surrounded by an opening sealing gasket system 51 that only allows, for a given fluid compartment, namely one among the anodic compartment, the cathodic compartment, and possibly a cooling compartment between two adjacent cells, for fluid communication of this given compartment only with the openings 36, 46 that allow the entry and exit of the fluid in this compartment. In practice, two series of opening sealing gaskets 51 are provided, one on the surface S′32, the other on the surface S′34.

In FIG. 3, the gaskets 50 and 51 are shown in dotted lines, seen through the half-bipolar plate 42. The gaskets 50 surround an internal zone Zint of the subassembly 6 wherein the CCM membrane 25, the gas diffusion layers 28 and 29, and the portions of galleries formed by the openings 36 and 46 are located. An external peripheral zone Zₑₓₜ of the subassembly 6 is defined around the gaskets 50, between these gaskets and the external edges of the subassembly. The gaskets 50 surround the different gaskets 51 that connect to the gaskets 50. In other words, the gaskets 51 are located in the internal zone Zᵢₙₜ.

An external peripheral zone Zₑₓₜ₃₀ of the frame 30 is defined as the zone of this frame that belongs to the external peripheral zone Zₑₓₜ of the subassembly 6 in the mounted configuration of this cell. The external peripheral zone Zₑₓₜ₃₀ thereby surrounds the gaskets 50, on each of the half-frames 32 and 34.

In order not to break the sealing ensured by the gaskets 50, and as visible in FIGS. 1 to 3, the first and second openings 320 and 340 are preferably arranged in the external peripheral zone Zₑₓₜ₃₀ of the frame 30, thereby in the external peripheral zone Zₑₓₜ of the subassembly 6.

A method for manufacturing a subassembly 6 as mentioned above is described below.

During a first preliminary step, the surfaces S32 and S34 are coated with glue. This preliminary step can be carried out on the site of manufacture of the membrane-electrode assembly 2, just before the following steps or in advance. Alternatively, this preliminary step can be carried out on a remote site, from which the glue-coated half-frames are transported to the site of manufacture of the membrane-electrode assembly. The operation of coating the surfaces S32 and S34 with glue can thereby be carried out by a different manufacturer than that who manufactures the membrane-electrode assembly. In such a case, a protective film can be provided on the glue layer for transport, this protective film being then removed before the second step described below.

During a second step, the two half-frames 32 and 34 are placed in contact by their surfaces S32 and S34 along the plane π30, while the membrane 22 is disposed between them, which has the effect of pinching the edge 22a of the membrane 22 and joining the frame 30 and the membrane 22, i.e. the frame 30 and the CCM membrane 25. The frame 30 is constituted by the adhesion of the surfaces S32 and S34 by means of the glue that is coated on them.

Advantageously, during the second step, the assembly of the two half-frames 32 and 34, by trapping the edges of the membrane 25, is carried out by activating the glue by applying ultrasound. Typically, the assembly of the two half-frames 32 and 34 trapping the membrane 25 is clamped between a sonotrode and an anvil, and the ultrasound transmitted by the sonotrode to the two half-frames 32 and 34 ensures the activation of the glue, thereby the bonding of the two half-frames 32 and 34 to each other and, in the overlap zone, the bonding of the two half-frames 32 and 34 with the membrane. Conventionally, the application of ultrasound can be implemented notably by means of a grooved sonotrode, such as those known e.g. from U.S. Pat. No. B10,981,245 or US-A-2013/213552. Typically, as illustrated in US-A-2013/213552, the grooving can e.g. be formed of two or three networks of grooves formed on the surface of the sonotrode, each network including grooves parallel to each other in a direction specific to each network. The grooves of the networks thereby delimit together, protruding studs that are the preferred contact zones with the frame during the application of ultrasound. It is noted that the use of a grooved sonotrode can form, on the surface at least of the half-frame with which the sonotrode is in contact, a texturing of the surface of the half-frame that is substantially the inverted image of the grooving of the sonotrode. This texturing can have a depth less than the depth of the grooving of the sonotrode. The sonotrode may be grooved over the entire surface thereof in contact with the two half-frames 32 and 34, or over only part of the surface thereof. Preferably, the entire surface of the two half-frames 32 and 34 is assembled by ultrasound. In other words, the bonding zone of the two half-frames, which corresponds to the zone where the ultrasound is applied, then corresponds to the entire area of the frame 30. In some embodiments, the entire bonding zone of the two half-frames, which corresponds to the zone where the ultrasound is applied, has a texturing of the surface of the half-frame that is substantially the inverted image of the grooving of the sonotrode. In other embodiments, only one or a plurality of portions of the bonding zone of the two half-frames, which corresponds to the zone where the ultrasound is applied, has such texturing, other portions of the bonding zone resulting from the activation of the glue by means of a smooth sonotrode or a smooth portion of the sonotrode. In the overlap zone of the frame 30 with the membrane 25, the ultrasound causes the bonding of each of the two half-frames 32 and 34 on the corresponding face of the membrane. Preferably, it is avoided that the sonotrode comes into contact with the membrane 25 inside the window delimited inside each half-frame, to avoid heating and compressing the membrane 25 in the actually active part thereof that will be exposed to the reactants. The sonotrode used can be in the form of a frame, possibly allowing for the complete assembly of the frame 30 on the membrane 25 in a single operation. Alternatively, provision can be made to use a sonotrode covering only part of the desired bonding zone, the complete assembly of the frame 30 on the membrane 25 can then be carried out in several successive operations. Alternatively, provision can be made to use several sonotrodes each covering only part of the bonding zone, the complete assembly of the frame 30 on the membrane 25 able then to be carried out in a single operation for all the sonotrodes simultaneously, or in several successive operations with one or a plurality of sonotrodes used in each operation.

During a third step, the diffusion layers 28 and 29 are deposited on the frame 30 and then assembled on same by any appropriate technique, e.g. by bonding.

During a fourth step, the two half-bipolar plates 42 and 44 are applied on either side of the frame 30 equipped with the CCM membrane 25 and the GDL layers 28 and 29, more precisely on the external surfaces S′32 and S′34 of the half-frames 32 and 34. The locations and dimensions of the cutouts 48 and 49 are chosen so that, at the end of the fourth step, the half-bipolar plate 42 covers the openings 320 and the cutouts 48 are aligned, parallel to the axis A30, with the openings 340, while the half-bipolar plate 44 covers the openings 340 and the cutouts 49 are aligned, parallel to the axis A30, with the openings 320. Thereby, in a direction parallel to the axis A30, each opening 320 is disposed between a solid portion 42A of the half-bipolar plate 42 and a solid portion 34A or 34B of the half-frame 34, facing a cutout 49, and each opening 340 is disposed between a solid portion 44A of the half-bipolar plate 44 and a solid portion 32A or 32B of the half-frame 32, facing a cutout 48. The solid portions 32A and 34A of the half-frames 32 and 34 are constituted, in this embodiment, at their longitudinal ends 32A and 34A. The solid portions 32A and 34A of the half-frames 32 and 34 are constituted by zones respectively devoid of openings 36 and openings 320 or 340. At these solid portions 32A and 34A, the surfaces S32 and S34 are not interrupted. The solid portions 42A and 44A of the half-bipolar plates 42 and 44 are constituted by zones devoid of openings 46 or other opening or cutout respectively. At these solid portions 42A and 44A, the surfaces S42 and S44 are not interrupted.

The geometry of the GDL 28 is such that said geometry does not interpose between the first openings 320 and the solid portions 42A of the half-bipolar plate 42 that are facing the openings 320, to allow for direct contact, through a given first opening 320, of the solid portion 34A, corresponding to this given first opening 320, of the half-frame 34, with the solid portion 42A corresponding to this given first opening 320, of the half-bipolar plate 44. Similarly, the geometry of the GDL 29 is such that said geometry does not interpose between the second openings 340 and the solid portions 44A of the half-bipolar plate 44 that are facing the openings 340, to allow for direct contact, through a given second opening 340, of the solid portion 32A, corresponding to this given second opening 340, of the half-frame 32, with the solid portion 44A corresponding to this given second opening 340, of the half-bipolar plate 42. In both cases, such relative positioning can be achieved by the geometry of the external contour of the GDL 28, 29, as in the illustrated example, or can be achieved by the presence of an opening in the GDL 28, 29. A solid portion of a half-frame or a half-bipolar plate corresponds to a first or second opening when said solid portion is aligned with, in other words facing, this opening, in a direction parallel to the axis A30.

Thereby, a nine-layer structure is formed, namely the three layers 22, 23, and 24 of the CCM membrane 25, the two half-frames 32 and 34, the two GDLs 28 and 29, and the two half-bipolar plates 42 and 44. This multilayer structure is intended to form the subassembly 6, at the end of the method of the invention.

A fifth step of joining the first and second half-bipolar plates 42 and 44 with the frame 30 is implemented by activating, e.g. by heating the glue present on the surfaces S32 and S34, at least over the extent of the solid portions 34A of the half-frame 34 that are facing the first openings 320, and over the extent of the solid portions 32A of the half-frame 32 that are facing the second openings 340. This activation can optionally be completed by a pressing operation to ensure the contact, through the first and second openings 320 and 340, of the glue thereby activated with the corresponding solid portion 44A, 42A of the half-bipolar plate 44, 42. The optional pressing can be concomitant, at least in part, with the activation. The pressing can follow the activation or can begin before or during the activation and continue beyond the activation. Thereby, through a given first opening 320, the solid portion 34A of the half-frame 34, which is facing this given first opening 320, is joined to the corresponding solid portion 42A, of the half-bipolar plate 42, which is also facing this given first opening 320, notably by the glue initially carried by the solid portion 34A of the half-frame 34. It can thereby be considered that at least part of the glue initially carried by the half-frame 34 migrates, through the given first opening 320, to reach the surface S42 of the half-polar plate 42. Similarly, through a given second opening 340, the solid portion 32A of the half-frame 32, which is facing this given second opening 340, is joined to the corresponding solid portion 44A of the half-bipolar plate 44, which is facing this given second opening 340, notably by the glue initially carried by the solid portion 32A of the half-frame 32. It can thereby be considered that at least part of the glue initially carried by the half-frame 32 migrates through the given second opening 340 to reach the surface S44 of the half-polar plate 44.

Moreover, the activation of the glue can, notably in the case of thermoplastic glues activated by heating, have the effect of fluidifying this glue and allowing part of this glue, notably that located near and around a given first and/or second opening 320 and 340, to then migrate into this opening 320 and 340 in the direction of the surfaces S44 and S42 respectively.

In particular, the heating of the glue present on the surface S34 can also have the effect of causing part of the glue present between the half-frames 32 and 34 to flow into the openings 320. Similarly, the heating of the glue present on the surface S32 can also have the effect of causing part of the glue present between the half-frames 32 and 34 to flow into the openings 340. Thereby, during the fifth step, the glue previously coated on the surfaces S32 and S34 can flow between these surfaces and migrate into the nearest hollow volumes constituted by the openings 320 and 340. From there, the glue flows, in these openings, towards the edges of these openings that adjoin the surfaces S42 and S44 of the half-bipolar plates 42 and 44 that said glue reaches at the end of the fifth step.

The above assumes such migration of the glue “near and around” the first and/or second openings. This implies that the glue is activated, notably by heating, over an area that covers these openings and the area of which is strictly greater than that of these openings.

During the fifth step, the first half-bipolar plate 42 is joined to the frame 30 thanks to the glue present in the openings 320, while the second half-bipolar plate 44 is joined to the frame 30 thanks to the glue present in the openings 340.

The fifth step is advantageously carried out by applying a localized heat source 82 on the half-frame 34, located in alignment with each opening 320 in a direction parallel to the axis A30, and by applying a localized heat source 84 on the half-frame 32, located in alignment with each opening 340 in a direction parallel to the axis A30, as shown in FIG. 4. The application of the heat source 82 or 84 allows the local temperature of the glue to be raised, to ensure the activation thereof and, possibly, to facilitate the flow thereof into the openings 320 and 340.

The heat source is advantageously a heating rod that can be manipulated by hand by an operator or by a robot and that comprises a heating resistance. The heating rod can notably be of the type of a manual soldering iron stylus. The heating rod can also be a system operating by impulse.

Optionally, a mechanical force, i.e. a pressure of the heat source in the direction of the frame is exerted jointly with the supply of heat, which allows for the activation of the glue and the assembly of the frame 30 with the half-bipolar plate 42 to be secured.

Here the heating rod 82 is inserted, in a direction parallel to the axis A30, into a cutout 49 and/or the heating rod 84 is inserted, in a direction parallel to the axis A30, into a cutout 48, to bring heat as close as possible to the glue coated on the surface S34 or S32, by direct application on the zone Z4 or Z2 of the half-frame 34 or 32 accessible through the cutout in question.

Alternatively, only one of the half-bipolar plates 42 or 44 is equipped with cutouts. The fact that the cutouts 48 and 49 each open onto at least one longitudinal edge of the half-bipolar plates 42 and 44, facilitates the contact between the heating rod 82 or 84 and the half-frame 32 or 34.

Alternatively, during the fifth step, the heating of the glue is carried out by radiation, by convection, notably with blown hot air, by applying ultrasound or ultraviolet rays. The choice of the heating mode, thereby of the heat source used, depends on the type of glue used and the geometry of the half-bipolar plates and the frame.

In addition and advantageously, as already mentioned above, a step of pressing the multilayer structure, in a direction parallel to the axis A30, can be implemented, as well as a step of applying vibrations to the glue present in the multilayer structure. This pressing and this vibration facilitate the migration of the glue, from the surfaces S34 and S32 in the direction of the surfaces S42 and S44 respectively, within the openings 320 and 340 and/or can facilitate the contact of this glue with the surface S42 and S44 through the openings 320 and 340. The pressing can be localized, e.g. concentrated on the extent of the first and second openings, or can be extended to a larger area of the multilayer structure, possibly to the entire surface of the multilayer structure or to the entire portion of the surface of the multilayer structure that is located outside the perimeter of the GDLs 28 and 29.

Following the fifth step, a quantity Q2 of glue initially located on the surface S34 is present in each opening 320, so that said glue connects the surface S42 to the portion of the surface S34 located facing this opening 320 and possibly to the edge of this opening that adjoins the surface S34, i.e. at the solid portion 34A of the half-frame 34 that is facing the opening 320. In addition, a quantity Q4 of glue initially located on the surface S32 is present in each opening 340, so that said glue connects the surface S44 to the portion of the surface S32 located facing this opening 340 and possibly to the edge of this opening that adjoins the surface S32, i.e. at the solid portion 32A of the half-frame 32 that is facing the opening 340. In other words, the quantity of glue Q2 generally comes mainly from the glue initially coated on the surface S34, while the quantity of glue Q4 generally comes mainly from the glue initially coated on the surface S32. In this regard, the fact that there is no overlap between the openings 320 and 340 ensures that a solid portion of a half-frame, coated with glue, is exposed, through each opening 320 or 340, facing a solid portion of the opposite half-bipolar plate. Thereby, the quantities of glue Q2 and Q4 that extend respectively in the openings 320 and 340 ensure the bonding, either of the first half-bipolar plate 42 or of the second bipolar plate 44, on the frame 30, without direct connection between these two half-bipolar plates 42, 44 through the frame 30.

The glue constituting a quantity Q2 can be formed by the sole quantity of glue present on the portion of the surface S34 facing an opening 320, while the glue constituting a quantity Q4 can be formed by the sole quantity of glue present on the portion of the surface S32 facing an opening 340.

Alternatively, and as explained above, the glue constituting a quantity Q2 can be formed of the glue that was, prior to the fifth step, on the surface S34, both at and around an opening 320, while the glue constituting the quantity Q4 is formed by glue that was, before the fourth step, on the surface S32, both at and around an opening 340.

Preferably, the quantity Q2 of glue extends, within the first openings 320, parallel to the plane π30. In other words, the quantity Q2 of glue is not deformed during the assembly process, so that the quantity Q2 of glue is, on the finished product, not deformed, but instead parallel to the plane π30.

In other words, the method of manufacturing the subassembly 6 of the invention takes advantage of the fact that glue is applied to the surfaces S32 and S34 to use said glue, on the one hand, to join the half-frames 32 and 34 to each other and around the CCM membrane 25 and, on the other hand, to join the half-bipolar plates 42 and 44 onto the frame 30, without the use of additional glue, welding, or another means of assembly.

The section of the openings 320 and 340 may be chosen with a relatively small area, less than or equal to 50 mm², preferably 20mm². This avoids weakening the frame 30 while allowing for effective joining of the half-bipolar plates 42 and 44 onto the frame. In addition, the cross-section of the openings 320 and 340 can be chosen with an area greater than or equal to 5 mm², preferably 10 mm². This ensures that the glue surface in contact with a surface S42 or S44 is sufficient to ensure effective immobilization of the half-bipolar plate 42 or 44.

For example, the openings 320 and 340 can be circular, with a diameter between 3 and 8 mm, preferably about 5 mm, as shown in the figures. Alternatively, they can be of any other shape, e.g., polygonal (triangle, rectangle, pentagon, hexagon, etc.) or oblong, with a length in the range from 5 to 10 mm, e.g., 7 mm, and a width in the range from 2 to 5 mm. Of course, a larger size of the openings is also possible, in particular allowing the adhesion force to be increased, but with potentially repercussions on the total size, or on the positioning concerning the plate.

At the end of the fifth step of the method of the invention, the subassembly 6 constitutes an electrochemical cell and can be handled, by a human operator or a robot, without the risk of the different layers thereof separating from each other, as they are effectively held relative to each other by means of the glue coated on the surfaces S32 and S3 during the first preliminary step and of which a part is in the openings 320 and 340.

When several electrochemical cells have thereby been created, in the form of subassemblies 6, by repeating the first to fifth steps mentioned hereinabove, it is possible to continue the manufacture of the fuel cell 8 by forming, during a subsequent step, a stack, by juxtaposition of the different cells, as shown in FIG. 7 for the third embodiment. This subsequent step is easy and quick to implement, by handling the electrochemical cells each as a unit.

The first five steps mentioned above allow for the constitution of cells that have all their main components, comprising the CCM membrane 25 and the two half-bipolar plates 42 and 44, and which, in the context of normal handling, do not risk separating or accidentally shifting, which allows them to be tested, or even pre-activated. Indeed, creating an individual electrochemical cell in this way offers the opportunity to test said electrochemical cell afterward with appropriate tooling, tooling ensuring the different seals and allowing the reactants and possibly the cooling fluid to be supplied. Such test tooling is advantageously capable of, and designed to, measure the efficiency of the cell. Advantageously, the same tooling, or separate tooling, allows for at least partial electrochemical break-in, which is usually practiced after the stacking of the cells when the cell is assembled. Such activation, at least partial, allows the electrochemical performance to be brought to or close to the expected initial performance level. Such test and/or pre-activation operations allow for the validation of the operation and performance of the preassembled cell before integrating said cells into the stack.

In the first embodiment, the sealing of the anodic compartment, between the membrane-electrode assembly 2 and the anodic half-bipolar plate, and of the cathodic compartment, between the membrane-electrode assembly 2 and the cathodic half-bipolar plate, is ensured by the peripheral sealing gaskets 50 and the opening gaskets 51, and not by the pre-assembly of the membrane-electrode assembly 2 with one and/or the other of the half-bipolar plates, as described hereinabove. Indeed, this pre-assembly by the quantities Q2, Q4 of glue that extend through the first and/or second openings 320, 340 and that come from the glue coated on the first surface S34 of the second half-frame 34 or the glue coated on the second surface S32 of the first half-frame 32, only form a pre-assembly at point zones. This pre-assembly is thereby unable to ensure fluid sealing of the concerned compartment vis-à-vis the outside.

In the second to fourth embodiments shown in FIG. 5 and following, the elements analogous to those of the first embodiment bear the same references. In what follows, what distinguishes these embodiments from the first is mainly described. If a reference is mentioned in the rest of the description without being shown on one of FIGS. 6 to 8 or if a reference is shown on one of FIGS. 6 to 8 without being mentioned in the rest of the description, said reference designates the same object as that bearing the same reference in the first embodiment.

In the second embodiment, the half-bipolar plates 42 and 44 are devoid, for at least one opening 320 and/or 340, of a cutout comparable to the cutouts 48 and 49 of the first embodiment. More particularly, in some variants of this second embodiment, the half-bipolar plates 42 and 44 are entirely devoid of cutouts comparable to the cutouts 48 and 49 of the first embodiment, so that each second opening 340 is disposed between a solid portion 44A of the second half-bipolar plate 44 and a solid portion 32A of the half-frame 32 which is itself disposed facing a solid portion 42A of the first half-bipolar plate 42. In other words, at the second openings, the frame 30 is covered, on the two opposite sides thereof, by the half-bipolar plates 42 and 44. Thereby, the half-bipolar plates are simpler to manufacture than in the first embodiment and are interchangeable.

In this second embodiment, the heating of the glue is obtained by applying a heat source 84 not directly on the frame 30, as in the first embodiment, but on the portion 44A of the second half-plate 44, in the zone where it is desired to join said second half-plate to the frame 30, i.e. facing an opening 340. A quantity Q2 of glue, which has migrated from the glue layer previously coated on the surface S32 of the half-frame 32, then ensures the connection between the frame 30 and the half-bipolar plate 44 through the opening 320.

In an unrepresented variant, the heat source can be applied to the portion 42A of the first half-plate 42.

At each opening 320, the situation is symmetrical with respect to the plane π30, vis-à-vis that shown in FIG. 5.

This embodiment is simpler to implement than the previous one, at the cost of potentially less effective glue heating.

In FIGS. 6 and 8, the zones where it is preferable to arrange the first and second openings 320 and 340 are identified with single-line hatching, and the exclusion zones, where these openings are preferably not arranged, are identified with cross-hatching.

In the third embodiment of FIGS. 6 and 7, the subassembly 6 includes a system of peripheral sealing gaskets 50, which is formed using peripheral sealing gaskets ensuring the same function as the system of peripheral sealing gaskets 50 of the first embodiment. A system of opening sealing gaskets 51 is also provided, with the same function as the system of opening sealing gaskets 51 of the first embodiment.

In the third embodiment of FIGS. 6 and 7, the peripheral gaskets 50 partly ensure the sealing function of the openings, with the opening sealing gaskets 51 that connect with the peripheral gasket 50.

Compared to the first embodiment, an additional peripheral gasket 50 is disposed on the surface of the half-bipolar plate 42 opposite the frame 30, as visible in the upper part of inserts A) and B) of FIG. 7. According to an unrepresented variant of the invention, the same is true at the level of the opening sealing gaskets 51.

As visible in FIG. 7, the stack 60 of electrochemical cells 6, made within a fuel cell 8 according to the invention, comprises several electrochemical cells, formed by subassemblies 6 also according to the invention, which are separated by bipolar plates 4 each constituted by a first half-bipolar plate 42 belonging to a cell 6 and by a second half-bipolar plate 44 belonging to an adjacent cell 6, the frames 30 of these subassemblies being held tightly sealed with respect to the bipolar plates 4, with peripheral sealing gaskets 50, disposed notably along the longitudinal edges of the electrochemical cells and opening gaskets 51 that surround each of the openings 36, 46 forming the fluid flow galleries within the stack of electrochemical cells.

The peripheral sealing gaskets 50 delimit the inner limit of an external peripheral zone Zₑₓₜ of the subassembly 6 that is sealed with respect to the anodic, cathodic, and cooling fluid compartments. The external peripheral zone Zₑₓₜ of the subassembly 6 is thereby located outside relative to at least one peripheral sealing gasket 50 of the subassembly 6. It is in this external peripheral zone Zₑₓₜ, in particular external, relative to the peripheral gasket 50 provided between the frame 30 and the first half-bipolar plate 42, that it is preferably chosen to place the first openings 320 arranged through the first half-frame 32 and the solid portions 42A of the first half-bipolar plate 42. It is also in this external peripheral zone Zₑₓₜ, external, notably relative to the peripheral gasket 50 provided between the frame 30 and the second half-bipolar plate 42, that it is preferably chosen to place the second openings 340 arranged through the second half-frame 34 and the solid portions 44A of the second half-bipolar plate 44. For each electrochemical cell 6, the peripheral sealing gaskets 50 are generally disposed radially inwardly from the external edges of the half-bipolar plates and the external edges of the frame of the membrane-electrode assembly, so that it is indeed possible to use this external peripheral zone Zₑₓₜ to place the first openings 320 arranged through the first half-frame 32 and the solid portions 42A of the first half-bipolar plate 42, and/or the second openings 340 arranged through the second half-frame 34 and the solid portions 44A of the second half-bipolar plate 44. It is noted that it is possible to make provision so that the contour of the peripheral sealing gaskets 50 can be adapted, to locally present a detour inward, to increase the available external peripheral surface Zₑₓₜ around the first openings 320 and/or the second openings 340.

Moreover, on each side of the frame 30, the opening sealing gaskets 51 delimit, in combination with the corresponding peripheral sealing gasket 50 and around the openings 36, 46, gallery framing zones Z_{eg}. Six gallery framing zones Z_{eg} are thereby visible in FIG. 6. Each of the gallery framing zones Z_{eg} is fluidically isolated from the anodic, cathodic, and cooling fluid compartments. Each of the gallery framing zones Z_{eg} can also accommodate at least some of the first openings 320, arranged through the first half-frame 32 facing a solid portion 42A of the first half-bipolar plate 42, and/or at least some of the second openings 340, arranged through the second half-frame 34 facing a solid portion 44A of the second half-bipolar plate 44. It is noted, however, that each gallery framing zone Z_{eg} is likely to be fluidically connected with the gallery said zone surrounds.

Such zones can also be defined in the first and second embodiments, even if said zones are not formally identified in FIGS. 1 to 6.

In FIGS. 6 and 7, the presence of the bonding zones Z2, Z4 is illustrated, which correspond respectively to the position of the first openings 320 and the second openings 340, along the longitudinal edges of the subassembly 6, at the height of the active zone corresponding to the presence of the CCM membrane 25. However, these bonding zones Z2, Z4 could be, as in the example of FIG. 3, located near the longitudinal ends of the subassembly 6, e.g. longitudinally at the height of the openings 36, 46 of the subassembly 6, or even beyond the openings 36, 46 of the subassembly 6 in the longitudinal direction starting from the center of the subassembly 6. Alternatively, and as envisaged above, these bonding zones Z2, Z4 can be located in one or the other of the gallery framing zones Z_{eg}.

More precisely, it is particularly advantageous, as illustrated in FIG. 3, to provide at least four first openings 320 and, if applicable, at least four second openings 340, each located at one of the four corners of the membrane-electrode assembly, a corner being defined as a portion of the membrane-electrode assembly that is comprised in the external peripheral zone Zₑₓₜ and that is:
longitudinally at the height of the openings 36 of the frame 36 forming reactive or cooling fluid galleries of the subassembly 6, or beyond these openings 36, 46 in the longitudinal direction starting from the center of the subassembly 6;
and/or transversely at the height of the one of the openings 36 of the frame 36, forming a reactive or cooling fluid gallery of the subassembly 6, that is closest transversely to the considered longitudinal edge, or beyond this opening 36 in the transverse direction starting from the center of the subassembly 6.

In FIG. 7, but also in FIG. 4, it is illustrated that it is advantageous to provide that the solid portion 42A of the first half-bipolar plate 42, which is facing a first opening 320 of the first half-frame 32, and/or the solid portion 44A of the second half-bipolar plate 44, which is facing a second opening 340 of the second half-frame 34, is folded to be arranged, along the axis A30, at a position equal to the position of the median plane π30 of the frame 30 along the axis A30, or close to it, to minimize the deformation of the frame along the axis A30 at the place of the junction of the frame 30 with the corresponding half-bipolar plate 42. This position can be exactly that of the median plane π30 of the frame 30 along the axis A30, or be offset from that of the median plane π30 of the frame 30 by a value less than or equal to the thickness of the frame 30 along the axis A30, ideally offset from that of the median plane π30 of the frame 30 by a value equal to the thickness, along the axis A30, of the half-frame 32, 34 wherein the opening 320, 340 is formed.

In the example of FIGS. 6 and 7, the half-bipolar plates 42, 44 have reliefs along the axis A30, these reliefs corresponding to the bottoms of reactive fluid circulation channels, to separation teeth between two channels, to bearing surfaces for sealing gaskets 50, 51. These reliefs can be spaced from the median plane π30 of the frame 30 along the axis A30. However, it is seen that, just like in the example of FIG. 4, the first half-bipolar plate 42 is formed so that the solid portion 42A facing a first opening 320 is arranged in a position that, along the axis A30, is offset from that of the median plane π30 of the frame 30 by a value equal to the thickness, along the axis A30, of the half-frame 32 wherein the first opening 320 is formed.

Thereby, in the case of a half-bipolar plate formed using stamped metal sheet, the solid portion 42A of the first half-bipolar plate 42, which is facing a first opening 320 of the first half-frame 32, can correspond to a stamped shape of the sheet forming the first half-bipolar plate 42 and/or the solid portion 44A of the second half-bipolar plate 44, which is facing a second opening 340 of the second half-frame 34, can correspond to a stamped shape of the sheet forming the second half-bipolar plate 44.

In the embodiment of FIG. 8, the opening sealing gaskets 51 are separate from the peripheral gaskets 50 and thereby have a closed contour ensuring by themselves the sealing function, for each anodic, cathodic, or cooling fluid compartment, between the compartment concerned and at least those of the openings 36 and 46 that do not communicate with this given compartment. In the embodiment of FIG. 8, the opening sealing gaskets 51 each delimit a gallery framing zone Z_{eg} by themselves, and portions of the internal zone are located between two gallery framing zones Z_{eg}, as represented by the cross-hatched zones disposed between two opening sealing gaskets 51 in FIG. 8.

In this embodiment also, the first and second openings 320 and 340 are preferably arranged in the external peripheral zone Zₑₓₜ of the subassembly 6.

According to an unrepresented variant of the fourth embodiment, some or all of the bonding zones Z2, Z4 can be provided in one or a plurality of gallery framing zone(s) Z_{eg}. According to another unrepresented variant of the invention, applicable to all embodiments, only one of the first openings 320 or only some of said openings is/are arranged in the external peripheral zone Zₑₓₜ or in one or a plurality of gallery framing zone(s) Z_{eg}. Similarly, provision can be made that only one of the second openings 340 or only some of said openings is/are arranged in the external peripheral zone Zₑₓₜ or in one or a plurality of gallery framing zone(s) Z_{eg}.

Whatever the embodiment, in the stack, such as the stack 60 shown in FIG. 7, at least one of the electrochemical cells 6 is according to the invention. Preferably, for the sake of homogeneity, all the electrochemical cells 6 are according to the invention.

According to an unrepresented variant of the invention, applicable to all embodiments, the subassembly 6 comprises a first polar half-plate 42 on only one side, and this is joined to a second polar half-plate 44 to form a preassembled polar plate 4, before joining the frame 30 and the polar half-plate 42, with the bonding technique using, e.g., the first openings 320. In this case, the subassembly 6 is a multilayer structure that is not symmetrical with respect to the plane π30, since the two joined polar half-plates are located on the side of the half-frame 32. This subassembly 6 can be integrated into a stack of the type of stack 60 shown in FIG. 7, in one operation because said sub-assembly can be handled as a unit by an operator or a robot. Each subassembly 6 then constitutes part of an electrochemical cell, as said sub-assembly must be associated with the second half-bipolar plate 44 itself part of another preassembled bipolar plate 4 of an adjacent subassembly to constitute a complete cell. In this case, only the first openings 320 are arranged through the first half-frame 32, without the need to arrange second openings through the second half-frame 34, only the component of the fifth step shown in the upper part of FIG. 4, or a symmetrical component of that shown in FIG. 6, is implemented, and the glue can be coated only on the first surface S34 of the second half-frame 34. This embodiment does not allow for testing or pre-activating a cell before the stack is constituted.

The invention is shown in the figures in the case where the membrane 25 is of the CCM type, the catalytic layers 23, 24 being carried by the base membrane 22. The invention is also applicable to the case where the catalytic layers 23, 24 are carried by the diffusion layers 28 and 29, according to the CCB (“Catalyst Coated Baking,”) technology, or even in the case of a mixed assembly, with one of the catalytic layers 23, 24 being carried by the base membrane 22, and the other of the catalytic layers 23, 24 being carried by the corresponding diffusion layer 28 or 29.

Alternatively, the subassembly 6 does not comprise the diffusion layers 28 and 29, which can otherwise be omitted, and/or replaced by structures integrated into the bipolar plates 4.

Whatever the embodiment or variant considered, the quantity of glue Q2 or Q4 present in an opening 320 or 340 does not necessarily fill the entire volume of this opening.

In the embodiments mentioned above, the openings 320 and 340 have the same geometry, as shown in the figures. In an unrepresented variant, one or a plurality of the openings of a half-frame has/have a different geometry from that of

In the embodiments mentioned above, the openings 320 and 340 have the same geometry, as shown in the figures. In an unrepresented variant, one or a plurality of the openings of a half-frame has a different geometry from the other openings of this half-frame and/or one or a plurality of the openings of a half-frame has a different geometry from one or a plurality of openings of the other half-frame.

The embodiments and variants envisaged above can be combined to generate new embodiments of the invention.

1. A sub-assembly for a fuel cell stack comprising
a membrane-electrode assembly comprising
a membrane
a bipartite frame formed by
a first half-frame disposed on a first side of the membrane;
a second half-frame disposed on a second side of the membrane;
and at least one first bipolar half-plate,
wherein at least the second half-frame is coated, on a first surface facing a first surface of the first half-frame, with a layer of adhesive for securing the half-frames,
wherein
first openings arranged through the first half-frame are each disposed facing a solid portion of the first bipolar half-plate and facing a solid portion of the second half-frame, in a direction perpendicular to a main plane of the membrane; and
the first bipolar half-plate is secured to the frame by a quantity of adhesive that extends through the first openings and comes from the adhesive coated on the first surface of the second half-frame.

2. The sub-assembly for a fuel cell stack according to claim 1, wherein
said sub-assembly comprises a second bipolar half-plate disposed, relative to the membrane, opposite the first bipolar plate;
the first half-frame is coated, on the first surface thereof, with a layer of adhesive for securing the half-frames;
second openings arranged through the second half-frame are each disposed facing a solid portion of the second bipolar half-plate and facing a solid portion of the first half-frame, in the direction perpendicular to a main plane of the membrane; and
the second bipolar plate is secured to the frame by a quantity of adhesive that extends through the second openings and comes from the adhesive coated on the first surface of the first half-frame.

3. The sub-assembly for a fuel cell stack according to claim 2, wherein the first and second openings are offset from each other in at least one direction parallel to the main plane of the membrane, so that there is no overlap between these openings in the direction perpendicular to the main plane of the membrane.

4. The sub-assembly for a fuel cell stack according to claim 2, wherein the first bipolar half-plate is provided with cutouts aligned with the second openings and/or wherein the second bipolar half-plate is provided with cutouts aligned with the first openings, in the direction perpendicular to the main plane of the membrane.

5. The sub-assembly for a fuel cell stack according to claim 4, wherein a cutout opens onto at least one longitudinal edge of the bipolar plate wherein said cutout is formed.

6. The sub-assembly for a fuel cell stack according to claim 1, wherein each opening arranged through a half-frame has a cross-section with an area greater than or equal to 5 mm², preferably 10 mm², with a preferably circular, rectangular, or oblong shape.

7. The sub-assembly for a fuel cell stack according to claim 1, wherein the adhesive is thermo-activable and based on a thermoplastic polymer, notably EVA copolymer.

8. The sub-assembly for a fuel cell stack according to claim 1, wherein at least one of the first openings arranged through the first half-frame is arranged in an external peripheral zone of the sub-assembly said zone being located outside relative to a peripheral sealing gasket of the sub-assembly.

9. The sub-assembly for fuel cell stack according to claim 1, wherein the membrane-electrode assembly includes four corners, and wherein the sub-assembly includes at least four first openings arranged through the first half-frame and arranged in an external peripheral zone of the sub-assembly said zone being located outside relative to a peripheral sealing gasket of the sub-assembly, each in a corner of the membrane-electrode assembly.

10. The sub-assembly for a fuel cell stack according to claim 1, wherein at least one of the first openings arranged through the first half-frame and the solid portion facing said opening belonging to the first bipolar half-plate are arranged in a gallery framing zone, arranged around an opening 46 of the first bipolar half-plate, and fluidically isolated from at least one anodic or cathodic fluid compartment delimited in the sub-assembly, between the membrane-electrode assembly and the first bipolar half-plate.

11. A fuel cell comprising a stack of electrochemical cells, each with a membrane-electrode assembly and two bipolar half-plates, wherein at least one of the cells comprises, or is constituted by, a sub-assembly according to claim 1.

12. A method of manufacturing a sub-assembly comprising
a membrane-electrode assembly comprising
a membrane
a bipartite frame formed by
a first half-frame disposed on a first side of the membrane
a second half-frame disposed on a second side of the membrane
and at least one first bipolar half-plate,
this method comprising at least
a preliminary step of coating at least a first surface of the second half-frame with an adhesive; and
a step of securing the frame and the membrane by applying the first surface of the second half-frame, coated with adhesive, against the first surface of the first half-frame;
a step of applying the first bipolar half-plate against a second surface of the first half-frame opposite the first surface of this first half-frame;
a step of securing the first bipolar half-plate and the frame by migration of the adhesive coated on the first surface of the second half-frame, towards a surface of the first bipolar half-plate, through first openings arranged in the first half-frame, between the first and second surfaces thereof.

13. The method according to claim 12, wherein the sub-assembly comprises a second bipolar half-plate and wherein the method comprises at least
a preliminary step of coating at least a first surface of the first half-frame with an adhesive;
a step of applying the second bipolar half-plate against a second surface of the second half-frame opposite the first surface of this second half-frame;
a step of securing the second bipolar half-plate and the frame by migration of the adhesive coated on the first surface of the first half-frame, towards a surface of the second bipolar half-plate, through first openings arranged in the second half-frame, between the first and second surfaces thereof.

14. The method according to claim 12, wherein, during the securing step, the adhesive coated on the first surface of the second half-frame, and possibly on the first surface of the first half-frame, is heated at least in the vicinity of the first openings, and possibly at the second openings.
